(19) United States
(12) Patent Application Publication
(10) Pub. No.: US 2023/0104706 A1
(43) Pub. Date: Apr. 6, 2023

(54) Random Bit String Generator

(71) Applicant: Nippon Telegraph and Telephone Corporation, Tokyo (JP)

(72) Inventors: Motoki Asano, Tokyo (JP); Ryuichi Ota, Tokyo (JP); Takuma Aihara, Tokyo (JP); Tai Tsuchizawa, Tokyo (JP); Hajime Okamoto, Tokyo (JP); Hiroshi Yamaguchi, Tokyo (JP)

(73) Assignee: Nippon Telegraph and Telephone Corporation, Tokyo (JP)

(21) Appl. No.: 17/427,215

(22) PCT Filed: Feb. 21, 2020
(86) PCT No.: PCT/JP2020/007058

§ 371 Date: Feb. 7, 2022

(30) Foreign Application Priority Data
Mar. 6, 2019 (JP) 2019-040236

(51) Int. Cl. G06F 7/58; H03K 3/84

(52) U.S. Cl. CPC G06F 7/58; H03K 3/84

(57) ABSTRACT

An oscillation unit (101), a measurement unit (102), and a bit generation unit (103) are included. The measurement unit (102) chronologically measures oscillation (for example, thermal oscillation) of a set frequency generated in the oscillation unit (101) at each set time. The bit generation unit (103) generates a bit string by allocating one bit of 0 or 1 to each of sine and cosine components of the oscillation measured by the measurement unit (102).

### CROSS-REFERENCE TO RELATED APPLICATIONS

This application is a national phase entry of PCT Application No. PCT/JP2020/007058, filed on Feb. 21, 2020, which claims priority to Japanese Application No. 2019-040236, filed on Mar. 6, 2019, which applications are hereby incorporated herein by reference.

### TECHNICAL FIELD

The present invention relates to a random bit string generation device that generates a bit string.

### BACKGROUND

In recent years, non-Neumann computing devices using interaction of multibody physical systems have attracted attention. Non-Neumann computing devices can solve difficult combinatorial optimization problems which are difficult for Neumann computing devices of the related art to solve. Further, the principle of quantum mechanics is used, and thus more computing efficiency is expected (see NPL 1). In such types of computing devices, bit strings generated at random are used for computation.

### CITATION LIST

### Non Patent Literature

NPL 1—T. Kadowaki and H. Nishimori, “Quantum annealing in the transverse Ising model”, Physical Review E, vol. 58, no. 5, pp. 5355-5363, 1998.
NPL 2—I. Mahboob, H. Okamoto, H. Yamaguchi, “An electromechanical Ising Hamiltonian”, Science Advances, vol. 2, no. 6, e1600236, 2016.

### SUMMARY

### Technical Problem

To generate bit strings used for the above-described computing devices, however, control mechanism for bit signals and interaction between the bit signals are necessary in principle. However, there is a problem that the control mechanism becomes complicated in accordance with a computing scale. For example, in Ising computers using mechanical oscillators which have already been proposed, with regard to N bit signals, it is necessary to control an amplitude, a phase, and a frequency of an exciting oscillation source that controls N(N+1)/2 interactions between bits (see NPL 2).

Embodiments of the present invention have been devised to solve the foregoing problems and an objective of embodiments of the present invention is to generate a bit string at random without using a complicated control mechanism.

### Means for Solving the Problem

According to an aspect of embodiments of the present invention, a random bit string generation device includes: an oscillation unit supported to be able to oscillate above a substrate; a measurement unit configured to measure oscillation of a predetermined frequency generated in the oscillation unit at each set time; and a bit generation unit configured to generate a bit string in which a bit of 0 or 1 is allocated to each of sine and cosine components of the oscillation measured by the measurement unit.

In the example of the configuration of the random bit string generation device, the measurement unit may measure N (here N is an integer equal to or greater than 2) oscillations of predetermined frequencies. The bit generation unit may generate a 2N-bit bit string in which the bit of 0 or 1 is allocated to sine and cosine components of each of the N oscillations measured by the measurement unit.

In the example of the configuration of the random bit string generation device, the bit generation unit may further generate a sum frequency bit string in which the bit of 0 or 1 is allocated to each of the sine and cosine components of a sum frequency of the frequencies of the N oscillations measured by the measurement unit, and a difference frequency bit string in which the bit of 0 or 1 is allocated to each of the sine and cosine components of a difference frequency of the frequencies of the N oscillations measured by the measurement unit.

In the example of the configuration of the random bit string generation device, the measurement unit may be configured as a Doppler oscillometer that optically measures oscillation of the oscillation unit.

In the example of the configuration of the random bit string generation device, the oscillation unit may be formed of a silicon nitride, and tensile stress may be applied to the oscillation unit.

In the example of the configuration of the random bit string generation device, the oscillation unit may be formed of a piezoelectric material, and the measurement unit may measure polarization generated by the oscillation of the oscillation unit as an electric signal.

The example of the configuration of the random bit string generation device may further include an extraction unit configured to extract a bit string in which an evaluation value of a set cost function is less than a set threshold from bit strings generated by the bit generation unit.

### Effects of Embodiments of the Invention

As described above, according to embodiments of the present invention, since a bit string is generated by extracting a sine component and a cosine component from an oscillation frequency of a set frequency generated from an oscillation unit and allocating a bit of 0 or 1, a bit string can be generated at random without using a complicated control mechanism.

### BRIEF DESCRIPTION OF THE DRAWINGS

FIG. 1 is a configuration diagram illustrating a configuration of a random bit string generation device according to an embodiment of the present invention.

FIG. 2 is an explanatory diagram illustrating generation of a 2N-bit bit string from each frequency mode of N harmonic oscillator groups contained in an oscillation unit 101.

FIG. 3 is an explanatory diagram illustrating an optical measurement state of an oscillation amplitude of the oscillation unit 101 by optomechanical conversion of the Doppler effect.

FIG. 4 is an explanatory diagram illustrating a frequency f₁ and a frequency f₂ in a plurality of mechanical oscillation modes of the oscillation unit 101.

FIG. 5 is a configuration diagram illustrating a configuration of the random bit string generation device according to Example 1 of the present invention.

FIG. 6 is an explanatory diagram illustrating a maximum cut problem of 4-node undirected graphs which are all negatively weighted.

FIG. 7A is a histogram of a bit string pattern that is extracted with 0 as a threshold η by an extraction unit 113 of the random bit string generation device according to Example 1.

FIG. 7B is a histogram of a bit string pattern that is extracted with 0.1 as the threshold q by the extraction unit 113 of the random bit string generation device according to Example 1.

FIG. 7C is a histogram of a bit string pattern that is extracted with 0.2 as the threshold q by the extraction unit 113 of the random bit string generation device according to Example 1.

FIG. 8A is an explanatory diagram illustrating a state in which bit strings corresponding to label 3 in the histograms of FIGS. 7A to 7C are graphed.

FIG. 8B is an explanatory diagram illustrating a state in which bit strings corresponding to label 12 in the histograms of FIGS. 7A to 7C are graphed.

FIG. 9A is a characteristic diagram illustrating dependency of a correct answer probability P_{corr} obtained by (a sum of the numbers of occurrences of labels 3 and 12)/(a sum of the numbers of occurrences of all the extracted labels) to the threshold η.

FIG. 9B is a characteristic diagram illustrating dependency of a correct answer in a bit string obtained by the random bit string generation device according to Example 1 to the threshold η.

FIG. 10 is a configuration diagram illustrating a configuration of a random bit string generation device according to Example 2 of the present invention.

### DETAILED DESCRIPTION OF ILLUSTRATIVE EMBODIMENTS

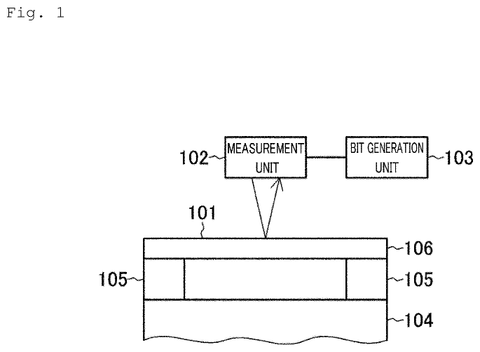

Hereinafter, a random bit string generation device according to an embodiment of the present invention will be described with reference to FIG. 1. The random bit string generation device includes an oscillation unit 101, a measurement unit 102, and a bit generation unit 103.

The oscillation unit 101 is formed in an oscillation layer 106 supported by support units 105 above a substrate 104. The oscillation unit 101 has, for example, a both-end supported beam structure and a gap between two support units 105 is configured to be able to oscillate. A mechanical oscillator is configured of the oscillation unit 101. The oscillation unit 101 (the oscillation layer 106) can be formed of, for example, a silicon nitride. The oscillation unit 101 (the oscillation layer 106) can be formed of, for example, a piezoelectric material.

The measurement unit 102 chronologically measures an oscillation (for example, thermal oscillation) with a set predetermined frequency generated by the oscillation unit 101 at each set time. The measurement unit 102 measures oscillation of N predetermined set frequencies (where N is an integer equal to or greater than 2). The measurement unit 102 can be configured as, for example, a Doppler oscillometer that optically measures oscillation of the oscillation unit 101.

The bit generation unit 103 generates a bit string in which one bit (bit value) of 0 or 1 is allocated to each of sine and cosine components of the oscillation measured by the measurement unit 102. The bit generation unit 103 generates a 2N-bit bit string in which the bit of 0 or 1 is allocated to sine and cosine components of each of N oscillations measured by the measurement unit 102. The bit string generated by the bit generation unit 103 is output from the random bit string generation device and is used for a non-Neumann computing device, as will be described below.

Here, the oscillation unit 101 formed of a silicon nitride capable of realizing a high Q value of mechanical oscillation by tensile stress can measure thermal oscillation of the oscillation unit 101 with higher sensitivity. Here, the thermal oscillation is caused by an ambient temperature where the oscillation unit 101 is disposed. When the oscillation unit 101 is formed of a piezoelectric material, in this case, a practitioner can electrically measure an oscillation amplitude of the oscillation unit 101 using the measurement unit 102 and can read a bit value of a generated bit string as an electric signal through the electromechanical conversion such as a piezoelectric effect. The electric signal subjected to electromechanical conversion is decomposed into sine and cosine components at each frequency of an oscillation mode by the bit generation unit 103 configured as a lock-in amplifier or the like, so that a random bit string can be obtained as time-series data.

According to the embodiment, a positive or negative value of the oscillation amplitude is allocated to a bit value in a harmonic oscillator group driven at random by thermal noise. In the embodiment, by continuously measuring the bit values, bit strings in which all the combinations of bit values are realized are generated. An evaluation value of the bit string generated in this way is obtained with an appropriate cost function, as will be described below, and a bit string in which the obtained evaluation value is less than a set threshold is selected. Thus, it is possible to stochastically solve a combinatorial optimization problem using the selected bit string.

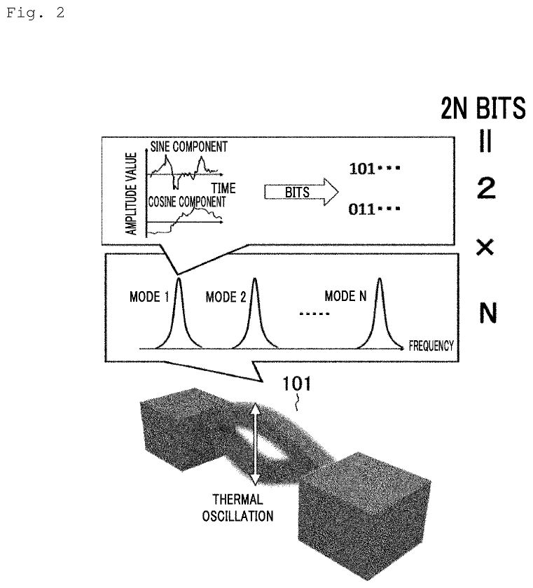

In the embodiment, a bit string is generated from finite thermal noise by using a harmonic oscillator group contained in the oscillation unit 101 serving as a mechanical oscillator, and the bit string can be used as a computing resource. According to the embodiment, it is possible to realize multiple bits through frequency multiplexing. In the embodiment, sine and cosine components orthogonal to each other in mechanical oscillation of the oscillation unit 101 are assumed to be independent bits. Thus, a 2N-bit bit string can be generated from each frequency mode of N harmonic oscillator groups contained in the oscillation unit 101 (see FIG. 2).

A combination of bit values of each bit string is shown as time-series data. However, to sufficiently ensure the randomness, it is necessary to set a time interval corresponding to the bits to be greater than a relaxation time of the mechanical oscillator.

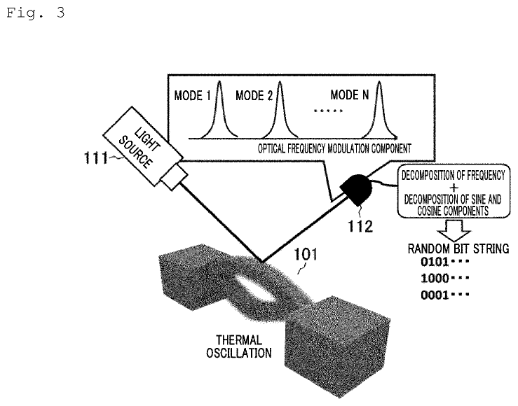

For example, reading of bit values is realized with light by optically measuring an oscillation amplitude of the mechanical oscillator through optomechanical conversion of the Doppler effect. For example, as illustrated in FIG. 3, the oscillation unit 101 is irradiated with laser light emitted from a light source 11 such as a semiconductor laser, reflected light reflected from the oscillation unit 101 is received by a detector 112 such as a photodiode, and photoelectric conversion is performed. An oscillation amplitude of the mechanical oscillation generated in the oscillation unit 101 is converted into a frequency modulation component (beats of the frequency of light) of the reflected light. The frequency of the reflected light is read by the detector 112 and is converted into an electric signal. In this way, by decomposing the electric signal output from the detector 112 into sine and cosine components for each frequency of the oscillation mode using a lock-in amplifier or the like, it is possible to generate a random bit string as time-series data.

Further, by using nonlinearity associated with the optomechanical conversion, it is possible to configure a value of a cost function from a complex amplitude product of the plurality of harmonic oscillators, and thus it is possible to perform evaluation using the cost function of the generated bit string. Thus, the computation of the cost function of the generated bit string can be simultaneously performed with the nonlinearity associated with the measurement of the oscillation by the above-described optomechanical conversion. By using a computation result of the cost function obtained in this way, it is possible to further simplify the generation control of a target bit string.

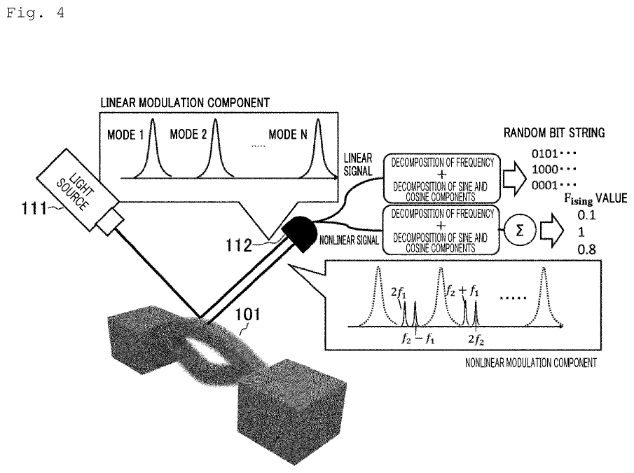

For example, as illustrated in FIG. 4, a frequency f₁ and a frequency f₂ in a plurality of mechanical oscillation modes of the oscillation unit 101 are conceived. With nonlinearity of the above-described optomechanical conversion, spectra corresponding to a sum frequency f₁+f₂, a difference frequency f₁−f₂, a double frequency 2f₁, and a double frequency 2f₂ can be simultaneously obtained in addition to signals with the frequency f₁ and the frequency f₂. The sine and cosine components of the spectra can be expressed as products of respective combinations of bit values x_{S}⁽¹⁾ and x_{C}⁽¹⁾ corresponding to the sine and cosine components of f₁ and bit values x_{S}⁽²⁾ and x_{C}⁽²⁾ corresponding to the sine and cosine components of f₂, as shown in Table 1. For example, the bit values x_{S}⁽¹⁾ and x_{C}⁽¹⁾ are “o” and the bit values x_{S}⁽²⁾ and x_{C}⁽²⁾ are “1”.

TABLE 1

| Frequency | Sine component | Cosine component |
|---|---|---|
| 2f1 | 2xS(1)xC(1) | (xS(1))2 − (xC(1))2 |
| 2f2 | 2xS(2)xC(2) | (xS(2))2 − (xC(2))2 |
| f2 − f1 | xC(1)xC(2) + xS(2)xS(1) | xS(1)xC(2) − xS(2)xC(1) |
| f2 + f1 | xS(1)xC(2) + xS(2)xC(1) | xC(1)xC(2) − xS(2)xS(1) |

By using these, for example, it is possible to obtain a value F_{ising} of the cost function of an Ising model indicated in Expression (1) below. In addition, yᵢ and yⱼ are bit strings generated from a frequency fᵢ and a frequency fⱼ.

$$\begin{matrix}Math . 1 & \\ {F}_{ising} = {\sum }_{i \neq j} {J}_{ij} {y}_{i} {y}_{j} & ( 1 )\end{matrix}$$

That is, when F_{ising} is taken into account as a total sum of the products of the values (bit values) of two bit strings, the value F_{ising} of the cost function of any Ising model can be directly obtained through experimental measurement by summing up signals of products of bit values obtained from the sum frequency f₁+f₂, the difference frequency f₁−f₂, and the double frequencies 2f₁ and 2f₂ with appropriate weight.

As described above, according to the embodiment, an external exciting source and thermal source are not necessary and a combinatorial optimization problem can be solved spontaneously with the bit strings generated from mechanical oscillation based on natural heat brought by an experiment environment temperature. For example, by providing optical resonators with the oscillation unit interposed therebetween in an oscillation direction of the oscillation unit, it is possible to confine light emitted and reflected from the oscillation unit within the optical resonators and enhance the light. In this way, it is also possible to enhance the optomechanical conversion using the optical resonators and improve measurement sensitivity and nonlinearity with regard to the oscillation amplitude.

Hereinafter, the foregoing content will be described in detail according to examples. The present invention is not limited to the following examples.

### Example 1

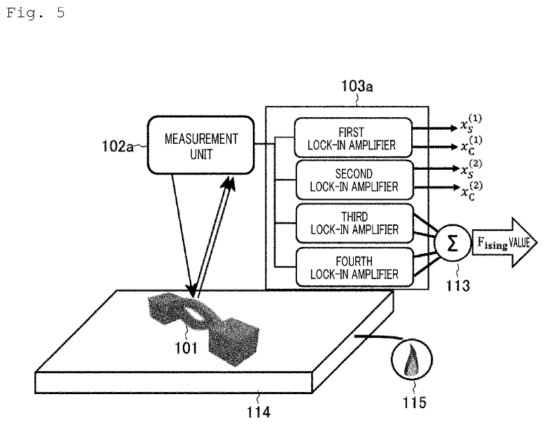

First, Example 1 will be described with reference to FIG. 5. A random bit string generation device according to Example 1 includes the oscillation unit 101, a measurement unit 102a, a bit generation unit 103a, and an extraction unit 113. In Example 1, a piezoelectric sheet 114 and any waveform generator 115 are included.

The oscillation unit 101 is formed of a silicon nitride and has a both-end supported beam structure. Abeam portion of the oscillation unit 101 has a length of 200 μm, a width of 5 μm, and a thickness of 525 nm. Tensile stress is applied to (intrinsic to) the oscillation unit 101. For example, the oscillation unit 101 is formed of a silicon nitride film formed by chemical vapor deposition in which deposition conditions such as a gas ratio of a raw gas and a deposition temperature are appropriately set, and thus the tensile stress can be applied to the oscillation unit 101. In the oscillation unit 101, a Q value of ˜10⁴ is shown. The oscillation unit 101 is disposed in a vacuum (evacuation) environment in which vacuuming of about ˜1×10⁻² is realized. The oscillation unit 101 is disposed on the piezoelectric sheet 114 to which a white noise voltage generated from any waveform generator 115 is applied.

The measurement unit 102a is configured as a laser Doppler oscillometer and measures oscillation of a first mode (f₁=510 kHz) and oscillation of a second mode (f₂=1710 kHz) generated by the oscillation unit 101 at set time intervals.

The bit generation unit 103a includes a first lock-in amplifier, a second lock-in amplifier, a third lock-in amplifier, and a fourth lock-in amplifier. The first lock-in amplifier extracts the first mode from an electric signal subjected to electromechanical conversion in the measurement unit 102a and decomposes the electric signal into sine and cosine components. The second lock-in amplifier extracts the second mode from the electric signal subjected to electromechanical conversion in the measurement unit 102a and decomposes the electric signal into sine and cosine components.

The third lock-in amplifier extracts a sum frequency of the first and second modes from the electric signal subjected to electromechanical conversion in the measurement unit 102a and decomposes the electric signal into sine and cosine components. The fourth lock-in amplifier extracts a difference frequency of the first and second modes from the electric signal subjected to electromechanical conversion in the measurement unit 102a and decomposes the electric signal into sine and cosine components.

The bit generation unit 103a generates a bit string in which the bit of 0 or 1 is allocated to each of the sine and cosine components extracted and decomposed by the first lock-in amplifier and a bit string in which the bit of 0 or 1 is allocated to each of the sine and cosine components extracted and decomposed by the second lock-in amplifier. The bit generation unit 103a generates a sum frequency bit string in which the bit of 0 or 1 is allocated to each of the sine and cosine components decomposed by the third lock-in amplifier and a difference frequency bit string in which the bit of 0 or 1 is allocated to each of the sine and cosine components decomposed by the fourth lock-in amplifier.

The extraction unit 113 extracts the bit string in which an evaluation value of a set cost function is less than a set threshold from the bit strings generated in the first and second modes by the bit generation unit 103a.

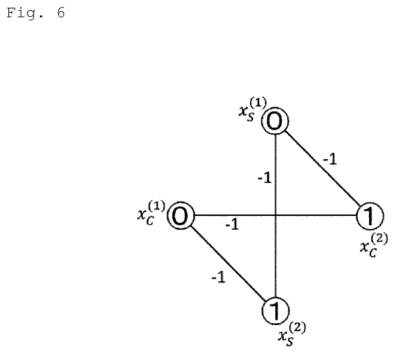

Hereinafter, a computation example in which the bit strings generated by the random bit string generation device according to Example 1 are used will be described. Here, a maximum cut problem of 4-node undirected graphs which are all negatively weighted, as illustrated in FIG. 6, is evaluated by a cost function of an Ising model from a 4-bit bit string obtained using the first and second modes of two frequencies. In FIG. 6, numbers in circles indicate values of bits. In FIG. 6, numbers given in coupling lines indicate weights of coupling magnitude of graphs. Here, the maximum cut problem of undirected graphs is a combined optimization problem in which classification into non-deterministic polynomial time (NP) hard classes is made.

The following cost function is obtained by performing the evaluation of the cost function with the nonlinearity of the optomechanical conversion by the measurement unit 102a, that is, the nonlinearity of the Doppler effect, and adding the sine component of the difference frequency component (the bit value of the sine component of the sum frequency bit string) and the sine component of the sum frequency component (the bit value of the sine component of the difference frequency bit string) which are nonlinear signals, using a negative weight (see Table 1).

Math. 2

F₄=−x_{C}⁽¹⁾x_{C}⁽²⁾−x_{S}⁽²⁾x_{S}⁽¹⁾−x_{S}⁽¹⁾x_{C}⁽²⁾−x_{S}⁽²⁾x_{C}⁽¹⁾ (2)

As described above, by disposing the oscillation unit 101a on the piezoelectric sheet 114, white noise is applied to the oscillation unit 101a and an effective temperature of each oscillation mode is raised to realize a sufficient S/N ratio to measure a nonlinear signal.

Extraction of a bit string in which a certain threshold η is determined and F₄≤η is satisfied from the bit strings output from the random bit string generation device of Example 1 by the extraction unit 113 and obtaining of a bit string with a high occurrence probability from the bit strings correspond to obtaining of an approximate solution of a maximum graph cut problem.

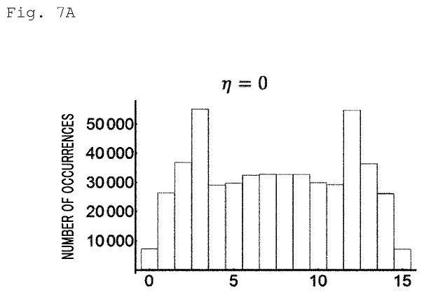

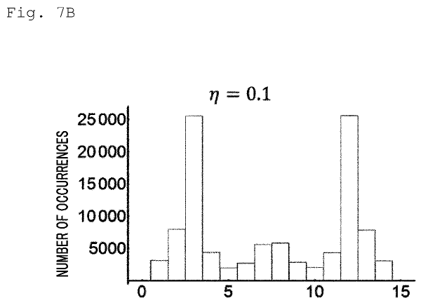

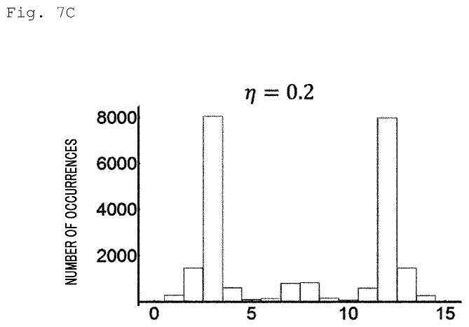

A histogram of a bit string pattern extracted with 0 as the threshold η is illustrated in FIG. 7A. A histogram of a bit string pattern extracted with 0.1 as the threshold η is illustrated in FIG. 7B. A histogram of a bit string pattern extracted with 0.2 as the threshold η is illustrated in FIG. 7C.

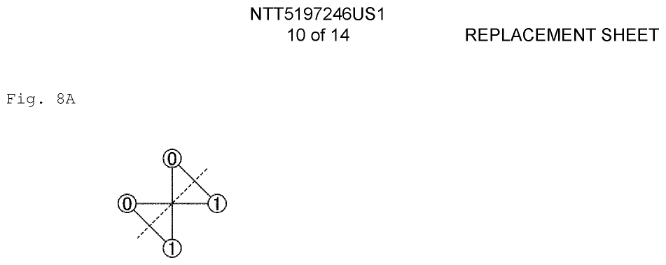

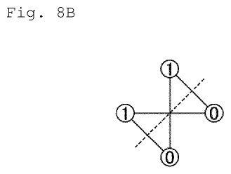

As the threshold η is lowered, the number of occurrences of bit strings corresponding to labels 3 and 12 in the histogram is considerably greater than the others. A graph of the bit strings corresponding to label 3 is illustrated in FIG. 8A. A graph of the bit strings corresponding to label 12 is illustrated in FIG. 8B. In FIGS. 8A and 8B, numbers in the circles indicate values of bits. A dotted line is a cut line. When a weight with magnitude of coupling of a graph is considered to be −1, as illustrated in FIGS. 8A and 8B, the obtained bit string can be clearly known to be a solution of the maximum graph cut problem.

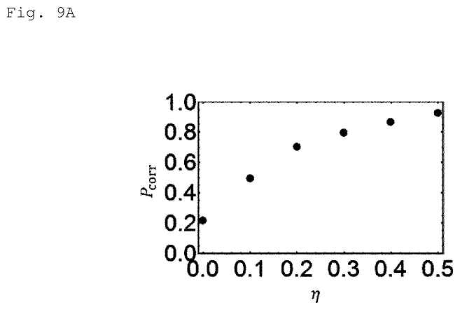

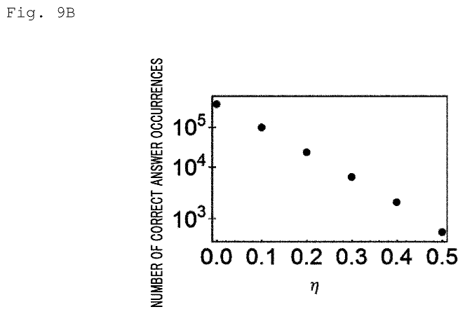

Dependency of a correct answer probability P_{corr} obtained by (a sum of the numbers of occurrences of labels 3 and 12)/(a sum of the numbers of occurrences of all the extracted labels) to the threshold η is illustrated in FIG. 9A. Dependency of the correct answer to the threshold η in the obtained bit string is illustrated in FIG. 9B. As illustrated in FIG. 9A, the correct answer probability P_{corr} becomes asymptotic to 1 as the threshold is raised. Thus, as illustrated in FIG. 9B, the number of obtained correct answers can be known to attenuate exponentially when the threshold is raised.

Incidentally, in the description of the foregoing Example 1, the cost function has been set from a sum frequency signal and a difference frequency signal in two mechanical oscillation modes. By expanding the modes to N mechanical oscillation modes and obtaining a double frequency signal of each signal in addition to the sum frequency signal and the difference frequency signal, it is possible to solve the maximum graph cut problem of a complete graph from 2N nodes.

In Example 1, the mechanical oscillator that has the both-end supported beam structure formed of a silicon nitride, is capable obtaining a high Q value with the tensile stress, and is capable of realizing high detection sensitivity with respect to thermal noise has been used, but neither the structure nor the material of the mechanical oscillator is limited thereto. It is preferable to use a mechanical oscillator appropriate for an operation environment (a temperature, the degree of vacuuming, and the like) of the computing device in which the generated bit strings are used.

In Example 1, a Doppler interferometer has been used as a measurement unit that causes and measures optomechanical conversion, but the present invention is not limited thereto. Any measurement unit can be used as long as the measurement unit is able to perform optomechanical conversion causing light phase modulation and frequency modulation and read the modulation components. For example, when a measurement unit is configured as an optical interferometer formed of an optical fiber, this device can be directly embedded in an optical fiber network.

### Example 2

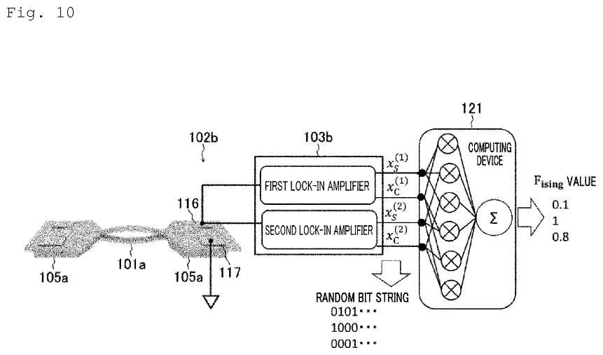

Next, Example 2 will be described with reference to FIG. 10. A random bit string generation device according to Example 2 includes an oscillation unit 101a, a measurement unit 102b, a bit generation unit 103b, and an extraction unit 113.

The oscillation unit 101a is formed of a piezoelectric material. Support units 105a that support the oscillation unit 101a are included. The oscillation unit 101a and the support units 105a are integrated. In this example, the oscillation unit 101a has a both-end supported beam structure supported by two support units 105a. For example, the oscillation unit 101a and the support units 105a can be formed of a compound semiconductor such as GaAs.

The support unit 105a includes a Schottky-connected first electrode 116 and an ohmic-connected second electrode 117. The second electrode 117 is installed. The measurement unit 102b is configured of the first electrode 116 and the second electrode 117. The measurement unit 102b measures oscillation of the oscillation unit 101a as an electric signal. A signal of polarization (surface charges) generated by causing the oscillation unit 101a to oscillate (thermally oscillate) is output to the bit generation unit 103b.

The bit generation unit 103b includes a first lock-in amplifier and a second lock-in amplifier. The first lock-in amplifier extracts the first mode from an electric signal measured by the measurement unit 102b and decomposes the electric signal into sine and cosine components. The second lock-in amplifier extracts the second mode from an electric signal measured by the measurement unit 102b and decomposes the electric signal into sine and cosine components. The bit generation unit 103b decomposes the sine and cosine components of the frequency components using the lock-in amplifiers and generates bit strings.

By causing an external computing device 121 to compute products of the components of the random bit strings output from the bit generation unit 103b and a sum of the products, it is possible to obtain a value of any cost function. By providing any threshold η with respect to the cost function obtained through the computing of the computing device 121 and extracting bit strings equal to or less than the threshold, it is possible to solve the problem described in Example 1.

As described above, according to embodiments of the present invention, since a bit string is generated by extracting a sine component and a cosine component from an oscillation frequency of a set frequency generated from an oscillation unit and allocating a bit of 0 or 1, a bit string can be generated at random without using a complicated control mechanism.

The present invention is not limited to the above-described embodiment and it should be apparent to those skilled in the art that many modifications and combinations can be implemented within the technical spirit of the present invention.

### REFERENCE SIGNS LIST

101 Oscillation unit
102 Measurement unit
103 Bit generation unit
104 Substrate
105 Support unit
106 Oscillation layer.

1-7. (canceled)

8. A random bit string generation device comprising:
an oscillator configured to oscillate above a substrate;
a measurement device configured to measure oscillation of a predetermined frequency generated in the oscillator at each set time; and
a bit generator configured to generate a bit string, wherein a bit of 0 or 1 of the bit string is allocated to each of a sine component and a cosine component of the oscillation measured by the measurement device.

9. The random bit string generation device according to claim 8, wherein the measurement device is configured to measure N oscillations of predetermined frequencies, wherein N is an integer equal to or greater than 2, and wherein the bit generator is further configured to generate a 2N-bit bit string in which a bit of 0 or 1 is allocated to a sine component and a cosine component of each of the N oscillations measured by the measurement device.

10. The random bit string generation device according to claim 9, wherein the bit generator is further configured to generate:
a sum frequency bit string in which a bit of 0 or 1 is allocated to each of a sine component and a cosine component of a sum frequency of the frequencies of the N oscillations measured by the measurement device; and
a difference frequency bit string in which a bit of 0 or 1 is allocated to each of a sine component and a cosine component of a difference frequency of the frequencies of the N oscillations measured by the measurement device.

11. The random bit string generation device according to claim 8, wherein the measurement device is configured as a Doppler oscillometer that optically measures oscillation of the oscillator.

12. The random bit string generation device according to claim 11, wherein the oscillator is formed of a silicon nitride, and wherein tensile stress is applied to the oscillator.

13. The random bit string generation device according to claim 8, wherein the oscillator is formed of a piezoelectric material, and wherein the measurement device is configured to measure polarization generated by oscillation of the oscillator as an electric signal.

14. The random bit string generation device according to claim 8 further comprising:
an extraction device configured to extract a bit string in which an evaluation value of a set cost function is less than a set threshold from the bit string generated by the bit generator.

15. A random bit string generation method comprising:
supporting and oscillating, by an oscillator, above a substrate;
measuring, by a measurement device, oscillation of a predetermined frequency generated in the oscillator at each set time; and
generating, by a bit generator, a bit string, wherein a bit of 0 or 1 of the bit string is allocated to each of a sine component and a cosine component of the oscillation measured by the measurement device.

16. The random bit string generation method according to claim 15, wherein the measurement device measures N oscillations of predetermined frequencies, wherein N is an integer equal to or greater than 2, and wherein the bit generator generates a 2N-bit bit string in which a bit of 0 or 1 is allocated to a sine component and a cosine component of each of the N oscillations measured by the measurement device.

17. The random bit string generation method according to claim 15 further comprising generating, by the bit generator:
a sum frequency bit string in which a bit of 0 or 1 is allocated to each of a sine component and a cosine component of a sum frequency of the frequencies of the N oscillations measured by the measurement device; and
a difference frequency bit string in which a bit of 0 or 1 is allocated to each of a sine component and a cosine component of a difference frequency of the frequencies of the N oscillations measured by the measurement device.

18. The random bit string generation method according to claim 15, wherein the measurement device is a Doppler oscillometer that optically measures oscillation of the oscillator.

19. The random bit string generation method according to claim 18, wherein the oscillator is formed of a silicon nitride, and wherein tensile stress is applied to the oscillator.

20. The random bit string generation method according to claim 15, wherein the oscillator is formed of a piezoelectric material, and wherein the measurement device measures polarization generated by oscillation of the oscillator as an electric signal.

21. The random bit string generation method according to claim 15 further comprising:
extracting a bit string in which an evaluation value of a set cost function is less than a set threshold from the bit string generated by the bit generator.
